(19) United States
(12) Patent Application Publication
(10) Pub. No.: US 2009/0044150 A1
(43) Pub. Date: Feb. 12, 2009

(54) SYSTEM AND METHOD FOR SIMPLIFIED NAVIGATION

(75) Inventors: Agnes LIU, Los Angeles, CA (US); Francisco Vinoly, Venice, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/835,271

(22) Filed: Aug. 7, 2007

(51) Int. Cl. G06F 3/048

(52) U.S. Cl. 715/854

(57) ABSTRACT

This disclosure describes systems, methods and user interfaces for easily navigating through hierarchically related content, such as web pages in a hierarchical website. For each page of content, a navigation element is provided that displays to the viewer of the page information about one or more pages that are hierarchically below the currently displayed page and information about what page or pages are hierarchically above the currently displayed page. The navigation element includes a top-level tabbed bar that exposes the hierarchical path from the homepage to the displayed page. Furthermore, as the user navigates through the website, the top-level bar forms a “crumb” or path describing the user's location within the hierarchy of web pages.

### BACKGROUND

Many web sites now include many different web pages that are hierarchically related. The ability to easily navigate between web pages of a web site is important to facilitate user accessibility.

Currently, information about how to access other pages in a web site is presented by links on the web page. As a user views various web pages, the links typically change to show what web pages are hierarchically arranged under the currently viewed page. For example, if a user is viewing a U.S. News web page, the web page may display links to web pages that are hierarchically categorized as a subset of the category U.S. News, e.g., web pages for U.S. Politics, U.S. Religion, U.S. Local, etc. Thus, when a user is viewing a web page, the user has easy access to those web pages that are categorized as hierarchically beneath the currently viewed web page.

### SUMMARY

This disclosure describes systems, methods and user interfaces for easily navigating through hierarchically related content, such as web pages in hierarchical websites. For each page of content, a navigation element is provided that displays to the viewer of the page information about one or more pages that are hierarchically below the currently displayed page and information about what page or pages are hierarchically above the currently displayed page. The navigation element includes a top-level tabbed bar that exposes the hierarchical path from the homepage to the displayed page. Furthermore, as the user navigates through the website, the top-level bar forms a “crumb” or path describing the user's location within the hierarchy of web pages.

In one aspect, the disclosure describes a method for displaying information about the hierarchical relationship of a displayed page of content with other pages. The method includes receiving a first request from a client for a requested web page containing content. The method then identifies one or more child web pages that are hierarchically beneath the requested web page. The method also identifies a parent web page that is hierarchically above the requested web page. The method further includes generating a navigation bar containing at least one first control element located in a first row and a second control element located in a second row above the first row. In the navigation bar, each first control element identifies a different one of the child web pages and, when selected, causes the transmission of a second request for its identified child web page. The second control element identifies the parent web page and, when selected, causes the transmission of a third request for the parent web page. The method assembles a response web page that includes the content and the navigation bar and then transmits the response web page to the client.

In another aspect, the disclosure describes a graphical user interface for a first web page within a hierarchy of web pages. The graphical user interface includes a graphical window containing content of the first web page and a navigation bar. The navigation bar includes a first row of first navigational controls and a second row of second navigational controls beneath the first row. Each of the first navigational controls identifies a different second web page relatively higher in the hierarchy of web pages than the first web page. Each of the second navigational controls identifies a different child web page of the currently displayed web page.

In yet another aspect, the disclosure describes a method of displaying web page information to a user. The method includes receiving a request for a requested web page in a hierarchy of web pages and determining a hierarchical level of the requested web page within the hierarchy of web pages. The method generates a navigation element for the requested web page. The navigation element displays at least one first navigational control identifying a parent web page having a hierarchical level above the hierarchical level of the requested web page and a plurality of second navigational controls. Each second navigational control identifies a different child web page having a hierarchical level immediately below the hierarchical level of the requested web page. The method then transmits the requested web page with the navigation element in response to the request.

These and various other features as well as advantages will be apparent from a reading of the following detailed description and a review of the associated drawings. Additional features are set forth in the description that follows and, in part, will be apparent from the description, or may be learned by practice of the described embodiments. The benefits and features will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments systems and methods described below and are not meant to limit the scope of the disclosure in any manner, which scope shall be based on the claims appended hereto.

FIG. 1 illustrates a high level embodiment of a method for displaying navigation information related to a hierarchy of web pages.

FIGS. 2A through 2D illustrate different embodiments of navigation elements.

FIG. 3 illustrates an embodiment of a computing architecture for generating and displaying navigation elements for web pages of a hierarchical web site.

FIG. 4 illustrates another embodiment of a method for generating a web page with a navigation element.

FIG. 5 illustrates an embodiment of a graphical user interface of a browser displaying a web page with an embodiment of a navigation bar.

### DETAILED DESCRIPTION

A web browser is a software application that enables a user to display and interact with text, images, and other information typically located on a web page at a website on the World Wide Web or a local area network. Web pages are well known in the art, the term referring to a data structure containing information that may be interpreted by a browser to create a display of media content to a user. Web pages may include or identify text, images and other content to be displayed as well as substantial formatting information used by the browser when creating the display showing the content. The text and images displayed may be associated with information linking them to other web pages at the same or a different website. Web browsers allow a user to quickly and easily access information provided on many web pages at many websites by traversing these links.

Some of the web browsers available for personal computers include INTERNET EXPLORER, MOZILLA FIREFOX, SAFARI, NETSCAPE, and OPERA. Web browsers are the most commonly used type of HTTP user agent. Although browsers are typically used to access the World Wide Web, they can also be used to access information provided by web servers in private networks or content in file systems.

Related web pages are often categorized hierarchically. For example, a internet news web site may contain a large and complex hierarchy of web pages. The highest level of the hierarchy may be a home or splash web page. Beneath this level may be a group of web pages that are the next level down in the hierarchy. Beneath each of those second level web pages may be another level of web pages and so on. Thus, it is often considered that any given web page in a hierarchy may have one or more child web pages (i.e., web pages beneath it in the hierarchy) and one or more parent web pages. Parent web pages may in turn have their own parents, which may be referred to as grandparents of the given web page in order to identify the hierarchical relationship between the given web page and the parent of the parent of the given web page.

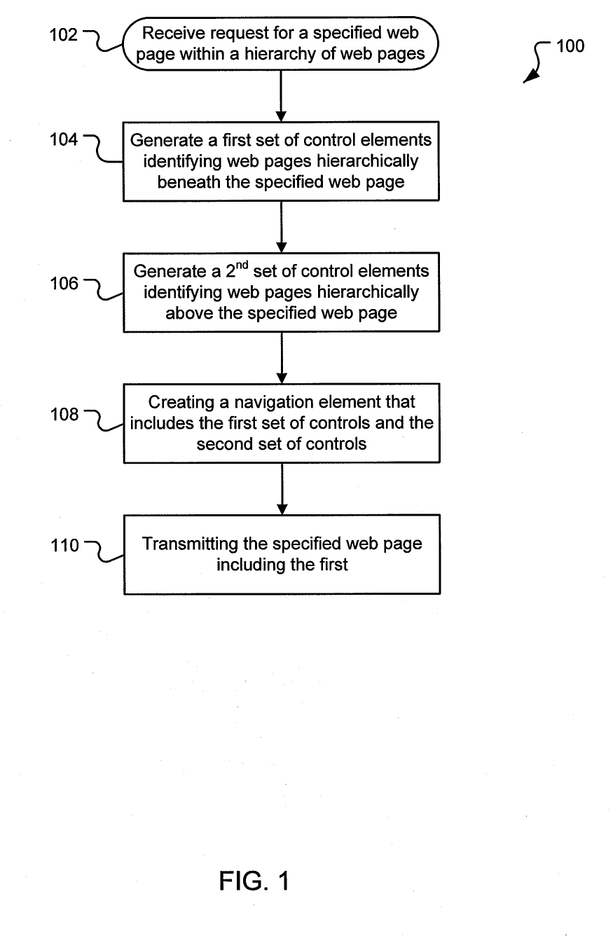

FIG. 1 illustrates a high level embodiment of a method for displaying navigation information related to a hierarchy of web pages. In the method 100 shown, a website that contains a hierarchy of web pages is provided. Any given web page within the hierarchy has a known level within the hierarchy. Pages above a given web page, i.e., pages having a higher level than a given web page, are referred to as parent web pages. Such pages may also be referred to as grandparents or great grandparents in order to identify the relative level between the two web pages. In addition, any given web page may have one or more child web pages or children. With reference to FIG. 1, the term children refers to all web pages in the level immediately lower within the hierarchy to a given web page.

The method 100 begins when a request is received for a specific web page within the hierarchy of web pages in a receive request operation 102. The receive request operation 102 may include receiving a request generated from another web page within the hierarchy or may be the result of a request generated by a browser, such as a web page address typed into an address bar of a browser.

Upon receipt of the request in the high level embodiment 100 shown, the web server in charge of responding to the request generates a first set of control elements identifying web pages hierarchically in the requested web page, i.e., a set of control elements for the children of the requested web page in a child control generation operation 104. As described in greater detail below, the child control generation operation 104 may require that the specified web page or the content of the specified web page be searched to determine the children of that web page. Alternatively, some other source of information describing the hierarchical relationship of the web pages may be accessed. For example, the system may have access to an electronic file that contains a listing of the hierarchical relationships between any given web pages in the website.

A second set of control elements is generated in a second generation operation 106. The second set of control elements identify one or more web pages hierarchically above the requested web page, i.e., parents of the requested web page. Depending on the number of parents a requested web page may have, more or less parent control elements may be generated. For example, if a web page has a parent web page and a grandparent web page, two control elements may be generated, one for each of the parent and grandparent. Alternatively, the system may only generate one control element for the parent. In yet another embodiment, parent control elements may be generated so that there are control elements for all web pages from a specified web page in the hierarchy, e.g., a home page, to facilitate a user's easy navigation back to that page and also provide the user visual information about where in the hierarchy the current page occurs.

The first and second generation operations 104, 106 are presented and discussed separately in the method 100 because the control elements created in each operation may be fundamentally different. For example, the child control elements may be control elements created in the form of a row of tabs allowing a user to select each of the control elements in order to be presented with the visual representation of selecting different tabbed pages. The second set of control elements, on the other hand, identifying parent web pages, may be different types of control elements, such as buttons, overlapping icons, or other shapes not presented as tabs, but are presented in order to show the viewer the hierarchical relationship between the parents and the current web page and the children.

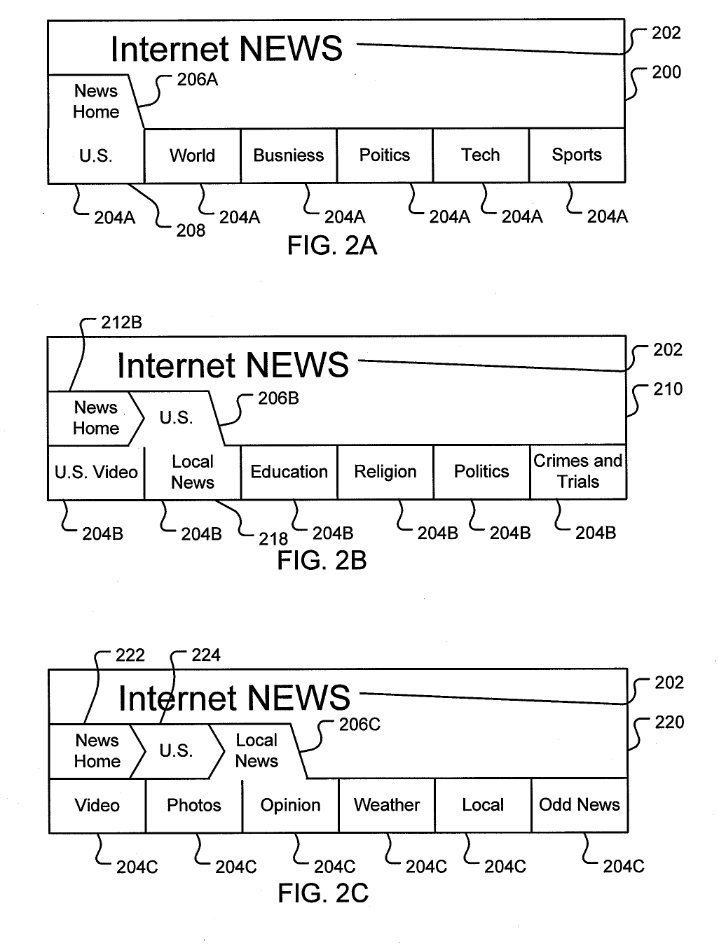

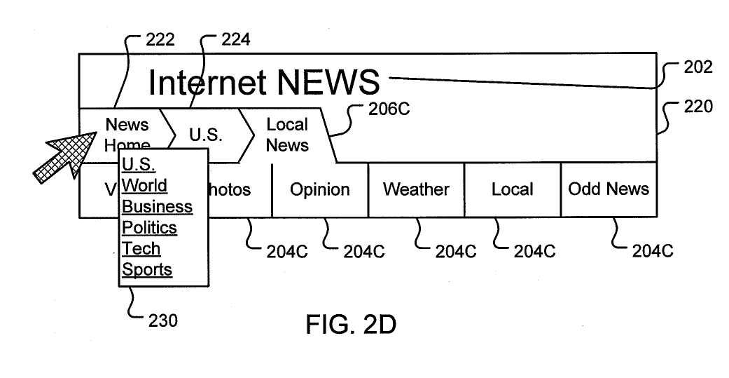

The second set of control elements may further include a control element for the current web page. This control element may not be a user selectable control, but rather simply be a visual identifier of the web page that is currently being viewed. Examples of control element embodiments are provided with reference to FIGS. 2A-2C below.

After the generation operations 104, 106, the control elements are used to create a navigation element, such as a navigation bar, in a create navigation element operation 108. The navigation element is a displayable element that includes the control elements created in the two generation operations described above. In an embodiment, the create navigation element operation creates a navigation element that through the layout of the control elements provides easy user access to child web pages of the requested web page and access to parents of the requested web page. Through the layout of the control elements and text provided, the viewer of the navigation element is also provided with information about how the requested web page is maintained within the hierarchy of web pages of the website. After the navigation element has been created, the content of the requested web page and the navigation element are combined in order to create a web page. This web page is then transmitted as a response to the original requester who sent the request for the web page in a transmission operation 110.

The method 100 may be performed in response to every web page request to a website. In this way, every web page of the website is displayed with a navigation element that presents hierarchical information regarding how the website is structured to the user and providing a navigation tool between the web pages. The reader will understand that as the user selects/clicks on the various controls that have been created in the generation operations 104, 106, that the navigation bar will be regenerated each time and packaged into a web page in response to the request.

FIGS. 2A through 2D illustrate different embodiments of navigation elements. The three FIGS. illustrate an embodiment of how the method 100 could be repeated in order to provide different navigation bars to the user as the user navigates through a hierarchical news website. The FIGS. 2A through 2C illustrate only embodiments of the navigation element for, and not the entire content, of a web page. The reader will understand that the content of a particular web page may be displayed below, above or to one side of the navigation elements shown.

FIG. 2A illustrates a navigation element for a home page or other web page that is at the highest level of a hierarchy. In the embodiment shown, an example of an Internet news site is used. FIG. 2A illustrates a navigation bar created for the home page of the Internet news site. The navigation bar includes a title block 202, a first control element 206A that identifies the displayed web page, and beneath the first control element 206A a group (in the embodiment shown, a group of six) of children to the home page. A control element 204A is provided for each child web page of the home page. In the embodiment shown, each control element 206A, 204A includes a textual identification of the title of the child web page and in each embodiment, each child control element 204A is a user selectable interface element through which a viewer of the navigation bar can select and be presented with the child web page. For example, of the six child control elements 204A shown, each one is given a different title: U.S., World, Business, Politics, Tech, and Sports. A user viewing this navigation bar could select U.S. and be presented with the child U.S. web page of the Internet news website. Alternative identifications could be instead or in addition to the textual identifications, such as images, designs, logos, icons, colors, etc. as desired by the website designer.

FIG. 2B illustrates the navigation element 210 created for the child U.S. web page of the web page for which the navigation element 200 was created. The navigation bar 210 may be generated in response to a user selection of the U.S. control element 208 shown in FIG. 2A. In addition, the same navigation bar 210 may also be presented in response to a user typing in the Internet address for the U.S. web page. Thus, the navigation bar may be the same regardless of the way in which the user request is generated for that web page.

As illustrated in FIG. 2B, the navigation bar 210 includes the title block 202 as described in FIG. 2A. In addition, it includes a current web page identifier control element 206B. However, the current web page control element 206B differs from that shown in FIG. 2A in that the current web page now is the U.S. web page and not the news home web page. However, in the embodiment shown, the U.S. web page is at a lower hierarchical level within the hierarchy of the news website, and a parent control element 212B is now displayed in the navigation bar. The parent control element 212B is displayed to the left of the currently displayed web page control element 206B in order to illustrate its parental status. In addition, in the embodiment shown, the parent control element 212B is further provided with a shape; in this case, an arrow shape indicating that it is hierarchically above the U.S. web page. The news home parent control element 212B may be a user selectable control element that, upon selection by a user, generates a request for the previous web page discussed with reference to FIG. 2A. In addition to the parent and current web page control elements 212B, 206B, the navigation bar 210 shown in FIG. 2B now displays a group of child control elements 204B, each corresponding to different web pages that are children of the currently displayed U.S. web page.

FIG. 2C shows a further example of a web page that would be displayed in response to a user selection of the local news control element 218 shown in FIG. 2B, or an independently generated request for the local news web page. In the embodiment shown, the navigation bar 220 now displays a grandparent control element 222 identifying the news home web page as the grandparent and a parent control element 224 identifying the U.S. web page as being the parent of the local news page such as currently displayed. A currently displayed website control element 206C is provided. The navigation bar 220 is further provided with a group of child control elements 204C, each child control element 204C corresponding to a different one of the web pages that are children of the currently displayed local news web page.

FIGS. 2A-2C illustrate how a navigation bar may be regenerated based on a user's selection of different control elements within the navigation bar. The FIGS. illustrate how, for any given web page, the user is presented with an easy means for requesting children web pages of the currently viewed web page and means for selecting any of the parent web pages of the currently viewed web page. Such information further allows the viewer to determine where within the hierarchy the viewer currently is. When a user navigates through the website by selecting one of the child controls, i.e., when a link in the second-level row of controls is activated, it will appear to move to the top-level, thereby forming a “crumb” or path describing the user's navigation through the site.

FIG. 2D illustrates another functionality of the navigation element. The parent control elements may be provided with a delayed drop-down menu that offers quick access to main categories of children of that parent. For example, the News Home button 222 has a delayed drop-down menu that offers quick access to main categories in the site. This is illustrated in FIG. 2D by the drop down menu 230 that shows and provides user-selectable links to the children of the home page as previously illustrated in FIG. 2A.

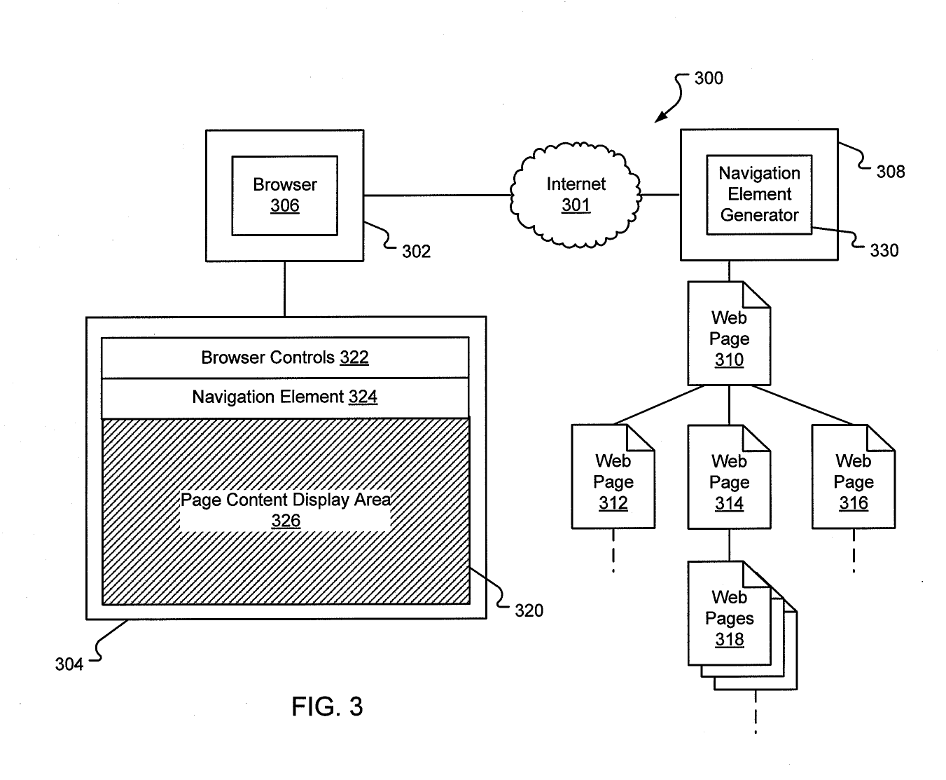

FIG. 3 illustrates an embodiment of a computing architecture for generating and displaying navigation elements for web pages of a hierarchical web site. The architecture 300 is a computing architecture in which a browser application 306 on a computing device 302 creates a browser window 320 on a display 304. The architecture 300 illustrated is a networked client/server architecture in which a computing device 302 (referred to as a “client”) issues web page requests to a remote computing device 308 (referred to as a “server”), which responds by transmitting the requested web page to the client for rendering to a user. The systems and methods described herein are suitable for use with other architectures as discussed in greater detail below.

For the purposes of this disclosure, a computing device such as the client 302 or server 308 includes a processor and memory for storing and executing data and software. Computing devices may be provided with operating systems that allow the execution of software applications in order to manipulate data. In the embodiment shown, the client 302 is a computing device, such as a personal computer (PC), web-enabled personal data assistant (PDA) a smart phone, or a laptop computer. The client 302 is connected to the Internet 301 via a wired data connection or wireless connection such as a wi-fi network, a WiMAX (802.36) network, a satellite network or cellular telephone network.

The client 302, in the embodiment shown, includes a browser 306 as discussed above. The browser 306 allows a user to input a web page identifier, such as a uniform resource locator (URL), a uniform resource identifier (URI), or a network address, or otherwise allows a user to issue commands that identify a web page 310, 312, 314, 316, 318 to the browser 306. In response, the browser 306 retrieves the web page 310, 312, 314, 316, 318 and displays it in the browser window 320. In an embodiment, the process of retrieval includes transmitting a request for the identified web page 310, 312, 314, 316, 318 via the network 301 to the server 308 as determined by the web page identifier. As is well known in the art, a web page identifier may identify a pre-existing data structure, such as a file stored on a server 308. Alternatively, a request for the web page 310, 312, 314, 316, 318 identified by a web page identifier may be interpreted by the server 308 to generate the web page in real time and transmit it in response to the request.

In the embodiment shown, the browser 306 is a software application that, when executed, generates a browser window 320 on a display 304 attached to or part of the computing device 302. The browser window 320 includes one or more browser controls 322, which may or may not be displayed in the form of a toolbar, through which the user of the client device 302 can interact to control the operation of the browser 306. For example, the controls 322 may include a button control for each of the forward-back-refresh-stop-home commands commonly associated with the rendering of web pages by browsers. By selection of these controls, the user may cause the browser 306 to transmit requests for and thereby retrieve the source code of the requested web page(s) 310, 312, 314, 316, 318 from the website server 308. The source code of the web page(s) 310, 312, 314, 316, 318 are then interpreted by the browser 306 to generate the content displayed in the content display area 326 of the browser window 320.

The browser window 320 further displays a navigation element 324. In the embodiment shown, the navigation element 324 is generated by the navigation element generation engine 330. The navigation element generation engine 330 is an independent application adapted to generate the source code for the navigation element 324. In an embodiment, this element 324 is then combined with the web page content 310, 312, 314, 316, 318 in order to generate a response to a web page request. In an embodiment, the navigation element generation engine 330 is a locally executing software module on the server 308.

In the embodiment shown, the navigation element 324 is located below the browser controls 322. However, the navigation element 324 could be placed within the browser window 320 in any location, e.g., located at the bottom of the browser window 320, on either side of the window 320, as a box within the window or above the browser controls 322.

The architecture 300 also includes one server 308 hosting the web pages 310, 312, 314, 316, 318 as known in the art. The server 308 may be a single server or a group of servers acting together. A number of program modules and data files may be stored in a mass storage device and RAM of the server 308, including an operating system suitable for controlling the operation of a networked server computer, such as the WINDOWS XP or WINDOWS 2003 operating systems from MICROSOFT CORPORATION.

In the embodiment shown, the server 308 hosts a hierarchical web site composed of a set of web pages 310, 312, 314, 316, 318. In the embodiment shown, three levels of the hierarchy are shown. At the highest level is a web page 310 which may be referred to as the home page, such as for example an Internet News Home web page. The home page 310 is hierarchically above three child web pages 312, 314, 316. Each of these web pages 312, 314, 316 may be hierarchically above other pages 318, which may themselves be hierarchically above yet other pages and so on.

In the embodiment shown, the content of web page 310, 312, 314, 316, 318 (as opposed to the navigation bar) is pre-generated and stored in a data structure such as an .HTML file. When requested, the navigation element generator 330 generates a navigation bar 324 for the requested web page, combines it with the content of the requested web page and transmits the resulting page and element combination to the requestor.

The reader will understand that this is but one embodiment of how a final web page containing a navigation element as described herein could be generated. Other methods could be used such as generating both the web page content and the navigation element on demand in real time in response to a request or, alternatively, generating both before a request and storing them as finished data structures in anticipation of future requests. Any known method for generating web pages could be adapted to generate web pages with the navigation elements as described herein and this disclosure should not be read as being limited to any particular web page generation method.

Local data structures, including discrete web pages such as .HTML files, may be stored on a mass storage device (not shown) that is connected to, or part of, any of the computing devices described herein including the client 302 or a server 308. The mass storage device includes some form of computer-readable media and provides non-volatile storage of data for later use by one or more computing devices. Although the description of computer-readable media contained herein refers to a mass storage device, such as a hard disk or CD-ROM drive, it should be appreciated by those skilled in the art that computer-readable media can be any available media that can be accessed by a computing device.

By way of example, and not limitation, computer-readable media may comprise computer storage media and communication media. Computer storage media include volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassette, magnetic tape, magnetic disk storage or other magnetic storage devices, or any other medium which can be used to store the desired information and which can be accessed by the computer.

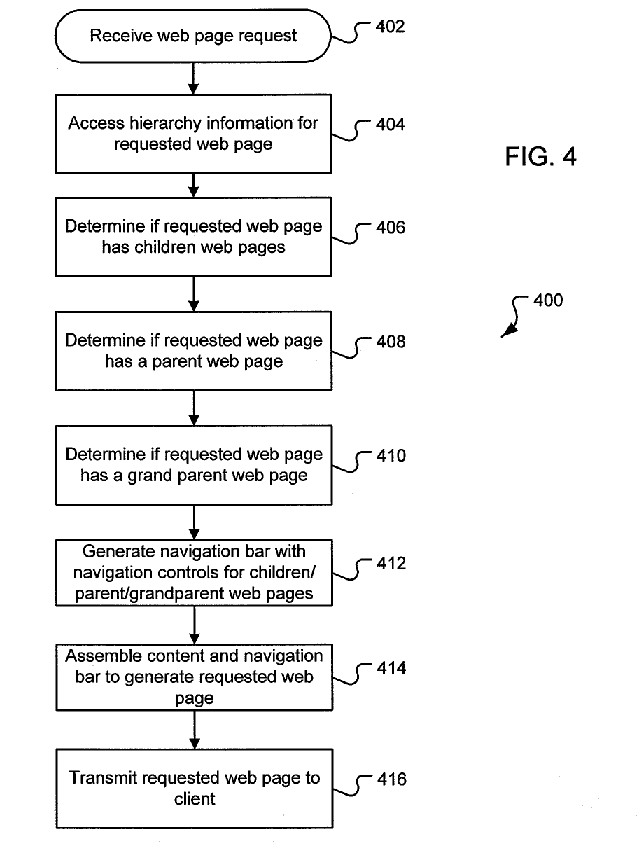

FIG. 4 illustrates another embodiment of a method for generating a web page with a navigation element. The method 400 begins with the receipt of a web page request in a receive request operation 402. The received request operation identifies a web page within a hierarchy of web pages of a website.

In response to the received request operation 402, an access operation 404 is performed in which hierarchy information is accessed in order to determine where in the hierarchy of web pages for the website the requested website appears. The access operation 404 may include accessing a data structure that contains the hierarchy information. Alternatively, the access operation may include scanning content of the requested web page in order to determine which web pages are identified as children to that page. Regardless of how the hierarchical information is maintained, the access operation 404 identifies the requested web page and determines the level within the hierarchy in which that web page is maintained.

This hierarchy information is then used in a first determination operation 406 to determine if the web page has children web pages. A second determination operation 408 is also performed to determine if the requested web page has parent web pages. A determination operation 410 may also be performed to determine if a grandparent web page exists to the requested web page; that is, whether the parent of the requested web page has itself a parent.

After the determination operations 406, 408, 410, a navigation bar is generated in a generation operation 412. The generate navigation bar operation 412 generates a navigation bar, such as the navigation bars shown in FIGS. 2A-2C. The generated navigation bar may include control elements for each parent, each grandparent, and each child web page identified in the determination operations. Alternatively, more parent control elements may be generated up to some maximum number of hierarchical levels or as necessary to show parent control elements back to some predetermined home or root web page. For example, only three levels of parents may be shown: a parent, a grandparent, and a great grandparent.

Similarly, not all of the children web pages may be provided with a control in the navigation bar. The navigation bar could rather include only the most popular, or the first group based on alphabetized names of the children, and further be provided with a control element that displays more controls for the children that are not displayed.

The generate navigation bar operation may further include selecting different shape control elements depending on the hierarchical relationship of a given page for which a control element is to be created and the requested page. For example, as shown in FIG. 2C, a parent may be provided with one shape of control element, such as an arrow shape pointing into the current web page control element. Alternatively, all the control elements may be the same shape and some other visual identifier of the relationship between the various web pages of the control elements may be shown, such as showing control elements overlapping in a certain way, lines between the elements, placing the elements within a visual tree structure, or lining the elements left to right, top to bottom, or other known ways.

After a navigation bar is generated, an assembly operation 414 retrieves the content for the requested web page and assembles the content and the navigation bar generated in the generate operation 410 to generate the requested web page. The web page is then transmitted in a transmission operation 416. A method 400 is easily adaptable to dynamic content as the dynamic content may only be retrieved at the same time that the navigation bar is also generated dynamically. Thus, even though the hierarchical structure of the website can be changed dynamically, each website transmitted in response to a request, will include the proper information about the hierarchical relationship of the pages in the navigation bar at the time the requested web page was assembled.

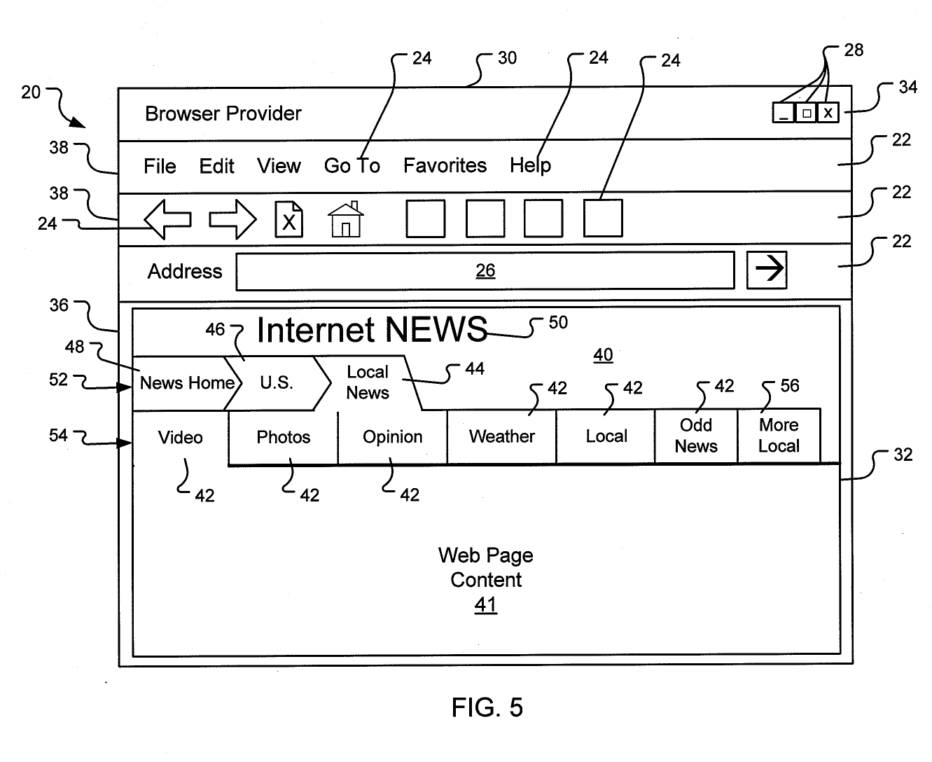

FIG. 5 illustrates an embodiment of browser interface 20 displaying a web page with an embodiment of a navigation bar as described above. The browser interface 20 includes a plurality of windows, each providing various functionalities to the Internet user unrelated to the web page being displayed. The browser interface 20 may comprise a first parent window 30 that typically defines the general size, color, and layout of the browser interface and includes window control buttons 28 (e.g., minimize, close, etc.) for that window 30. The browser interface 20 may also comprise a second parent window 36 (a child to the first parent window) within the first parent window 30, and one or more child windows 38 dependent from the second parent. The second parent window 36 and child windows 38 typically define information and/or functionality that will assist an Internet user when accessing and navigating the Internet.

For example, the second parent 36 and its dependent windows 38 may provide toolbars, pull-down menus, Plug-ins, applications, etc. For example, three windows 38 provided at the top (in the drawing) of the interface 20 define three toolbars 22, which may include a variety of interface controls 24 such as, for example, pull-down menus, functional buttons (e.g., stop, back, forward, home, etc.), and a combination of functional buttons and windows (e.g., a search button and window). The uppermost toolbar 22 provides a plurality of pull-down menus 24; the middle toolbar 22 provides a plurality of functional buttons 24; and the lowermost toolbar 22 provides a pull-down menu and a textbox element 26 (for entering URL addresses). A content window 32 is also provided as part of the interface 20 within which content from an Internet content provider such as web pages may be displayed. In an embodiment, the browser user may toggle any of the lower three (in the drawing) toolbars 22 on and off using a View toolbar object 24 (pull-down menu) provided in the second toolbar 22.

In the embodiment shown, the web page displayed by the browser in the content window 32 includes a navigation bar 40 above the web page content 41. The navigation bar includes two rows 52, 54 of selectable controls 42, 46, 48. The controls 42, 46, 48 may be displayed to appear as tabs, as shown in the lower row 54, or may be displayed as user-selectable buttons. In addition, a current web page control 44 is provided that indicates to the user the web page currently being viewed. The navigation bar 40 may be provided with a title block 50. Alternatively, the title block 50 could be a part of the web page content 41 and be separated from the other web page content by the navigation bar 40. In the embodiment shown, the navigation bar 40 includes a first row 52 of parent controls 48, 46 and the current page control 44 (which may not be a user-selectable control, but rather a simple, unselectable element). Below the parent control row 52, is a child control row 54 having seven child controls 42 in the form of tabs.

In addition, the child control row 54 includes a control 56 that, upon selection, shows information or controls for more children web pages of the current web page to the user. In this way, if a current page has a large number of children then a user may be made aware that additional children web pages which are not illustrated in the second row 54 exist and also provide a means for accessing them.

The navigation elements described herein encourage exploration of the other pages of the website and, thus, increases traffic to other parts of the site. The navigation bar gives context to users of where they are within the site, which is especially useful if they arrived at the website deep within the hierarchy. It also exposes the breadth of contextually relevant offerings at other levels in the hierarchy.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure. For example, the drop down menu 230 shown in FIG. 2D could appear after a delay over any of the parent or child control elements in a navigation bar. This would provide additional information to a user about the hierarchy of the website and easy navigation between the web pages in the hierarchy. In addition, although the systems and methods were described above with reference to a hierarchical website, they are also suitable for navigation through any hierarchically related pages or items of content of any kind. For example, navigating through a listing of media objects such as movies, new articles on related topics, databases of hierarchical listings, hierarchically nested user interfaces for a software application, etc. Numerous other changes may be made that will readily suggest themselves to those skilled in the art and which are encompassed in the spirit of the invention disclosed and as defined in the appended claims.

What is claimed is:

1. A method comprising:
receiving a first request from a client for a requested web page containing content;
identifying one or more child web pages that are hierarchically beneath the requested web page;
identifying a parent web page that is hierarchically above the requested web page;
generating a navigation bar containing at least one first control element located in a first row and a second control element located in a second row above the first row, wherein each first control element identifies a different one of the child web pages and, when selected, causes the transmission of a second request for its identified child web page, and the second control element identifies the parent web page and, when selected, causes the transmission of a third request for the parent web page;
assembling a response web page including the content and the navigation bar; and
transmitting the response web page to the client.

2. The method of claim 1 wherein generating the navigation bar further comprises:
generating a third control element located in the second row before the second control element, wherein the third control element identifies a grandparent web page and, when selected, causes the transmission of a fourth request for the grandparent parent web page.

3. The method of claim 2 wherein generating the navigation bar further comprises:
generating a fourth control element located in the second row before the third control element, wherein the fourth control element identifies a great grandparent web page and, when selected, causes the transmission of a fifth request for the great grandparent parent web page.

4. The method of claim 1 further comprising:
determining that the requested web page is in a hierarchy of web pages and is hierarchically above the one or more child web pages and hierarchically beneath the parent web page.

5. The method of claim 2 further comprising:
determining that the requested web page is in the hierarchy of web pages and is hierarchically above the one or more child web pages and hierarchically beneath the parent web page; and
determining that the parent web page is hierarchically beneath the grandparent web page.

6. The method of claim 3 further comprising:
determining that the requested web page is in hierarchy of web pages and is hierarchically above the one or more child web pages and hierarchically beneath the parent web page; and
determining that the parent web page is hierarchically beneath the grandparent web page and that the grandparent web page is hierarchically beneath the great grandparent web page.

7. The method of claim 1 wherein generating the navigation bar further comprises:
generating a fifth control element located in the second row after the second control element, wherein the fifth control element identifies the requested web page.

8. The method of claim 1 wherein generating the navigation bar further comprises:
generating a first control element for each child web page.

9. The method of claim 7 further comprising:
selecting a shape for each of the first, second and fifth control elements based on their hierarchical relationship to the requested web page.

10. A graphical user interface for a first web page within a hierarchy of web pages comprising:
a graphical window containing content of the first web page; and
a navigation bar containing a first row of first navigational controls and a second row of second navigational controls beneath the first row, wherein each first navigational control identifies a different second web page relatively higher in the hierarchy of web pages than the first web page.

11. The graphical user interface of claim 10 wherein each second navigational control identifies a different third web page immediately below the first web page in the hierarchy of web pages.

12. The graphical user interface of claim 10 wherein the second row includes a second navigational control for each third web page immediately below the first web page in the hierarchy of web pages.

13. The graphical user interface of claim 10 wherein the second row contains second navigational controls for some of the third web pages immediately below the first web page and contains an indicator indicating that the second row does not contain second navigational controls for all of the third web pages.

14. The graphical user interface of claim 10 wherein the first row further includes a third navigational control that identifies the first web page.

15. The graphical user interface of claim 14 wherein each first navigational control identifies a parent web page on a different hierarchical level above the first web page.

16. The graphical user interface of claim 14 wherein the first navigational controls are ordered in the first row based on the different hierarchical level of their identified web pages.

17. The graphical user interface of claim 16 wherein each of the first navigational controls has a shape that indicates its identified web page's order in the hierarchy relative to the other first navigational controls.

18. The graphical user interface of claim 16 wherein each first and second navigational control, upon selection, generates a request for the control's identified web page.

19. A method of displaying web page information to a user comprising:
receiving a request for a requested web page in a hierarchy of web pages;
determining a hierarchical level of the requested web page within the hierarchy of web pages;
generating a navigation element for the requested web page, the navigation element displaying at least one first navigational control identifying a parent web page having a hierarchical level above the hierarchical level of the requested web page and a plurality of second navigational controls, wherein each second navigational control identifies a different child web page having a hierarchical level immediately below the hierarchical level of the requested web page; and
transmitting the requested web page with the navigation element in response to the request.

20. The method of claim 19 wherein each of the first navigational control and second navigational control is a selectable control that, when selected, transmits a request for its identified web page.

21. The method of claim 19 further comprising:
generating the navigation element wherein the navigation element includes a different second navigational control for each child web page having a hierarchical level immediately below the hierarchical level of the requested web page.

22. The method of claim 19 wherein generating the navigation element further comprises:
placing the first navigational control in a first location in the navigation element to indicate that the first navigational control is hierarchically above the second navigational controls.

23. The method of claim 19 wherein generating the navigation element further comprises:
placing the first navigational control in the first location in the navigation element to indicate that the first navigational control is hierarchically above the request web page; and
placing the second navigational controls in a second location in the navigation element to indicate that the second navigational controls are hierarchically beneath the request web page.
